(19) United States
(12) Patent Application Publication
(10) Pub. No.: US 2004/0176963 A1
(43) Pub. Date: Sep. 9, 2004

(54) Interactive in-store sales support system

(76) Inventor: Philippe Vallerand, Monroe, WA (US)

Correspondence Address: Lawrence D. Graham, Esq., BLACK LOWE & GRAHAM PLLC, 816 Second Avenue, Seattle, WA, 98104, US

(21) Appl. No.: 10/379,326

(22) Filed: Mar. 3, 2003

(51) Int. Cl. G06F 17/60

(52) U.S. Cl. 705/1; 705/27

(57) ABSTRACT

An interactive in-store sales support system includes a computer and attached display, preferably having a touch-screen. The display is conveniently located within the store where it is readily accessible by customers, for example within a store aisle. The system provides access to remote vendors for special orders and technical support, and further is configured to provide training and inventory functions.

### FIELD OF THE INVENTION

This invention relates generally to interactive sales support systems including, for example, audio-visual systems providing information and access to remote personnel and systems.

### BACKGROUND OF THE INVENTION

Retail stores today are generally confronted by a similar set of problems. Stores face pressures to cut costs because of increasing competition, economic downturns, or other reasons. Because the largest cost component tends to be the employee payroll, managers frequently reduce the number of workers in order to cut costs.

Of course, eliminating workers brings a new set of problems. Customers may have trouble finding products or obtaining information about products they might like to purchase. Some of those customers will go elsewhere or will not make purchases they would have made if more assistance had been available. Thus, in many cases, an effort to reduce costs through staff reductions will also have an adverse effect on revenues.

In addition, in many commercial settings, the employee turnover is quite high. New employees often require training, and high turnover means that training is required frequently. Worse yet, the training is required with little notice, rather than at preset times, because employees come and go at unexpected times. In some cases, the training can be effectively provided by in-store personnel. In other cases, however, training is provided by a third party such as a vendor of goods sold by the retailer. Particularly in those instances, it can be quite inconvenient to provide instantaneous training on little or no notice. Yet without such rapid training, the vendor's sales may drop precipitously.

Accordingly, there is a need for a system that can overcome one or more of the above problems.

### SUMMARY OF THE INVENTION

The present invention comprises an interactive in-store sales support system. In a preferred form, the system includes an in-store computer and display that is accessible by customers. The computer provides for access to one or more remote computers or remote personnel over the internet, phone lines, or other communication channels. The remote computers or personnel are able to provide responses to inquiries related to goods or services sold by the commercial establishment. In a preferred form, the remote computers or personnel are affiliated with a particular vendor, and therefore provide sales support related to that vendor's products. Thus, using the system, customers are able to get additional information about products from a remote source just as they would if the remote computer or personnel were located in the store.

In various preferred embodiments of the invention, customers are able to actually speak to a remote vendor and see a live video image of the vendor personnel on the in-store display. In a dialogue with the remote vendor personnel, the customer can ask questions about products, place special orders, inquire about status of previous orders, and conduct other business. The customer can alternatively or at the same time view videos about product features, uses, installation, or other aspects. The videos are, for example, stored on the associated in-store computer or retrieved from the remote computer over the Internet or other communication channels.

In a preferred form, store employees can also use the same computer and display to communicate with remote vendor personnel to ask about products, obtain training, or conduct other business. Likewise, the employees can access training videos or related content from the remote vendor.

As another preferred aspect, the system can be used to place orders for additional inventory and to obtain reports regarding various uses of the system.

### BRIEF DESCRIPTION OF THE DRAWINGS

The preferred and alternative embodiments of the present invention are described in detail below with reference to the following drawings.

FIG. 1 is a perspective view of a representative preferred system of the present invention, shown installed in a typical commercial store aisle;

FIG. 2 is a detailed view of a representative display screen and associated computer, with the display illustrating a preferred content arrangement on the display screen;

FIG. 3 is a block diagram of a preferred embodiment, indicating interaction between the in-store system and various external components;

FIG. 4 is a more detailed view of a representative in-store system, omitting surrounding shelving and other typical store aisle components;

FIG. 5 is a flow diagram for a use of the preferred embodiment for inventory control and ordering;

FIG. 6 is a flow diagram for a use of the preferred embodiment for customer ordering and technical support interaction; and

FIG. 7 is a flow diagram for a sue of the preferred embodiment for employee training and report generation

### DETAILED DESCRIPTION OF THE PREFERRED EMBODIMENT

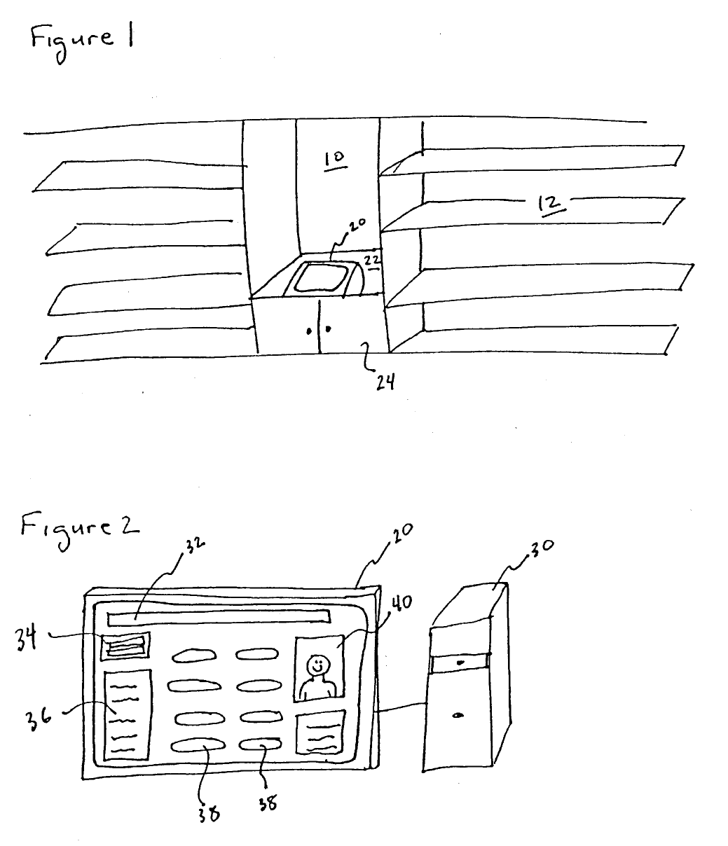

The preferred form of the present invention is designed for use in a store in a location that can be easily accessed by customers. For that reason, the system is representatively illustrated in FIG. 1 as being located within a typical store aisle 10 having a plurality of shelves 12. Because the present invention is not restricted to any goods or services, the shelves of FIG. 1 are not shown with any particular goods. Nonetheless, it should be appreciated that the shelves 12 would typically be stocked with goods even though not illustrated here. Likewise, though shown approximately in the center of a store aisle, the entire system may alternatively be located at either end of an aisle, at an aisle end cap, or in a more open setting apart from store aisles.

In its preferred form, the customer will primarily see an in-store computer monitor or other such display 20 residing on a countertop 22 and optionally including a cabinet 24. As discussed more fully below, the display 20 allows employees, contractors, customers, and others to access information and remote support personnel in order to facilitate sales, training, customer support, and other activities.

The display 20 is associated with an in-store computer 30, as shown in FIG. 2. The computer generally can be any processor-based device, such as a notebook, desktop, server, or other device. A typical desktop computer is preferred, and will also preferably include ports to allow communication via phone lines and LAN lines, and printing to an attached printer. Nonetheless, the computer need have nothing more than a processor, and specifically is not required to have peripheral components such as a keyboard, mouse, disk drive, and other such devices even though their inclusion is preferred.

The display 20 is preferably a standard touch-screen computer monitor such as a 17 inch flat panel LCD display. The display 20 alternatively may be a CRT, plasma, or other hardware device. In that regard, widescreen plasma displays are readily available with touch-screen overlays. The use of a widescreen display (e.g., a 42 inch plasma display) enhances the interactivity and allows for a greater number of persons to view the screen at any single time, and further allows viewers to see the information on the display in greater detail.

The computer 30 includes a memory containing stored programming instructions to present a variety of interactive presentations on the display 20, depending on the actions of the user. As explained more fully below, the computer programming causes the display to present audio-visual training demonstrations and information, interactive customer ordering information, technical support, and other features. In some instances, this information presented on the display is stored in an associated computer memory, while in other instances the information is retrieved from a remote memory over a LAN, Internet, or other communication channel. Further, as discussed below, the computer is in communication with telephone lines to allow telephone communication with others, using a speaker and microphone embedded in the display 20 or separate from but adjacent the display.

The display 20 is illustrated in FIG. 2 with a preferred layout of menu options and other information as a customer would see it when first approaching. Thus, the information presented on the display includes a banner 32 conveying a store name, product name, vendor name, or other such title related to the general information that can be accessed from the display. A login region 34 at the upper left representatively includes separate lines for entry of a user name and password. In order for the user to enter characters for these fields, a separate keyboard is provided (but not illustrated). Alternatively, a section of the screen can include a pictorial keyboard allowing for the entry of keystrokes via the touch-screen monitor.

A menu bar 36 is provided at the lower left of the screen, listing various choices available. A plurality of menu buttons 38 is provided in a central section of the screen. The menu buttons are preferably relatively large and relate to choices for consumers, such as requests for technical support, demonstrations, placing special orders, home installation instructions, and the like. The menu bar 36 can have similar options, or may alternatively include selections aimed at employees, contractors, and vendors, such as inventory orders, employee training videos, and the like.

A remote personnel section 40 is provided at the upper right of the display 20. In its static state, the remote personnel section 40 provides a still image of a representative person who may provide customer support or other assistance. As discussed further below, when the system is being used interactively by a customer, employee, or other person, the remote personnel section can optionally display a live image of a remotely located person providing technical support or other assistance.

No particular organization is required, and the screen display organization described above can be revised in any manner, consistent with this invention. Likewise, the screen can depict additional or fewer features than those described above.

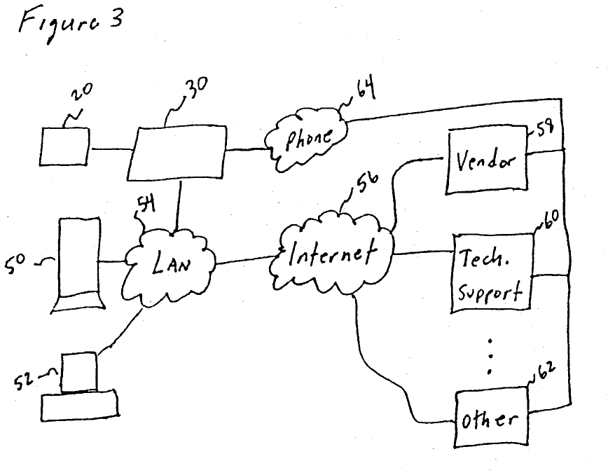

A block diagram of the various components and interactivity of a preferred form of the invention is shown in FIG. 3. The computer 30 and display 20 are illustrated in communication with a local area network (LAN) 54 that resides within a store. Any number of servers 50 and store computers 52 may also be connected and in communication over the LAN. The system is shown structurally connected through a LAN because it is contemplated that the preferred form of the invention is best suited for large stores having many computers networked together. Nonetheless, it is also readily adaptable to smaller stores having no other computers or using only stand-alone computers. For that reason, the LAN portion is not a required component of this invention. Likewise, any of the connections shown, such as the connection between the computer 30 and the LAN 54, can be either wired or wireless.

Any of the computers, including the in-store computer 30 connected to the display 20, may communicate with other hardware through the LAN and over the Internet 56. Accordingly, the in-store computer 30 can communicate, for example, with a remote vendor computer 58, technical support computer 60, or any other remote computer 62. As discussed further below, the communication between such computers allows the transmission, in either direction, of data, orders, audio-visual content, telephone voice and video communications, or other content. In addition, or alternatively, the in-store computer 30 is connected to standard phone lines 64 to allow a user to use the computer as a telephone to speak with any remote individuals. The remote individuals are not limited in any way, but typically include vendors, technical support personnel, and others.

In the preferred form, voice communication with remote personnel is accomplished through the computer, whether it is over phone lines or the Internet. In an alternate form, however, the voice communication can be provided as a separate, stand alone system, for example by using a speaker phone placed adjacent the computer. Even in this configuration, however, it is preferred that the separate phone system be sufficiently near the computer and monitor so that the monitor is in the field of view while the phone system is audible.

In another alternate form of the invention, customers and other users use voice commands to interact with the system, rather than touching touch-screen buttons. In this form, the computer 30 includes voice recognition software that is capable of interpreting voice commands from a user, particularly including expected responses to inquiries. Thus, to use the system the customer preferably initiates a session by touching the screen. Thereafter, the stored programming instructions cause the computer to make one or more requests of the user, such as to state a desired menu choice, by playing the request audibly over an attached speaker. The request to the user is preferably both an audible request as well as a visual request presented on the display, such as a welcome message and an invitation to indicate whether the user would like to place an order, get technical assistance, or has some other need. The computer then receives the vocalized response from the user via the microphone, and interprets the user commands and operates further instructions accordingly, in a manner similar to that if the user issued the command by touching a screen button. Thus, any of the touch screen commands of this invention can be alternatively invoked by using voice commands.

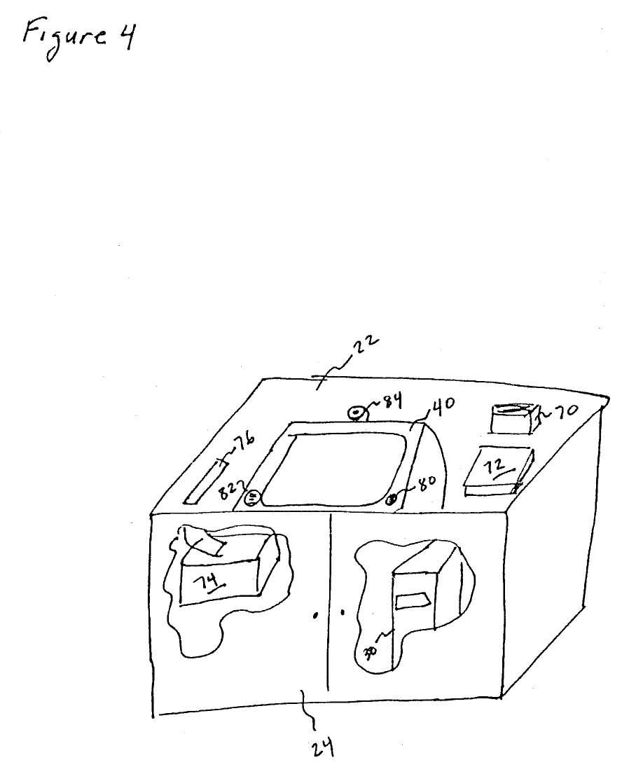

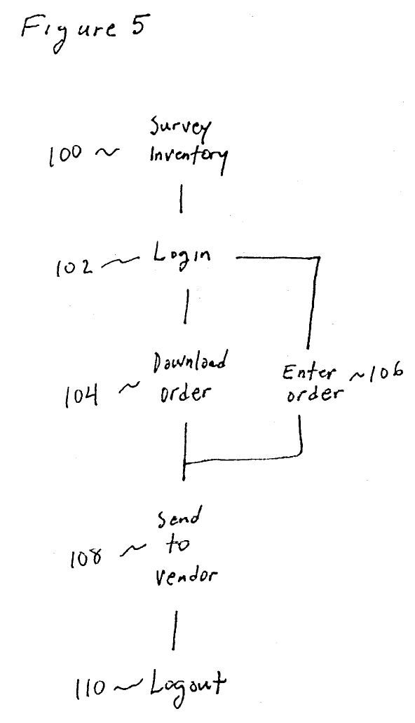

FIG. 4 depicts a more detailed illustration of the preferred in-store computer and display. Note that the embodiment of FIG. 4 omits surrounding store shelving as in FIG. 1. The structure of FIG. 4 can thus alternatively be incorporated into store aisles as with FIG. 1, or can be a stand-alone system such as in an isolated kiosk or an aisle end cap. As shown, the countertop 22 is preferably large enough to use as a writing surface and can include sample brochures 70, catalogs 72, or other product information. The cabinet 24 beneath the countertop houses the computer 30 and an attached printer 74. The printer is aligned with a slot 76 so that printed matter will extend through the slot after printing. The above construction is preferred because it houses much of the equipment and various wires in the cabinet, out of sight, but no particular construction or use of a cabinet is required.

The display 20 further includes an integral microphone 80, speaker 82, and camera 84 (though each of these accessories can be separate, rather than integral with the display). A microphone and speaker are preferred because they allow presentation of audio content and the ability of the customer or others to talk to remote support personnel. Likewise, a camera is useful to facilitate better remote support. For example, a customer can hold a sample or a product in front of the camera so that a remote support person can see the item. Some customers may not like having a camera directed to their face, however, and for that reason alternate embodiments include an ability to disable the camera and the use of a camera mounted above the countertop and trained downward toward the countertop rather than at the user. The customer can then place items in the field of view of the camera so that the computer 30 can send images over the network 56 to remote users.

FIG. 5 illustrates a flow diagram for a preferred method of using the system to place inventory orders. Initially, a user surveys current store inventory levels 100. The user in this instance can be a store employee a vendor, or a contractor. Surveying the current inventory levels can be a manual process in which the user makes notes on paper or fills in a form to record current inventory levels (which may be reflected, for example, as the quantity of goods in the store or the size of the order to be placed). Alternatively, the survey of current inventory levels can be performed electronically using a hand-held microprocessor based device to record stock orders. Such devices are widely available, and typically include a bar code reader to scan product or shelf bar codes and then enter associated numbers indicating order quantities.

After the inventory survey is completed, the user logs in to the system 102. Although it is preferable to login after the survey is completed, it is not necessary to do so. Thus, the user can login first, and then complete the inventory survey. The login step is useful to ensure that unauthorized users do not access the system and place large inventory orders. This step is particularly valuable because the computer 30 and display 20 are preferably located within a store where it is accessible to the public at large.

The login step preferably comprises entry of a username and password. Each of these fields is visible in the login section 34 of the screen in its static state. If a touch-screen display is used, the user touches the username portion of the login section and then enters a username in the username field, then tabs over or touches the password section and enters the password. Both the username and password are entered on an associated conventional keyboard or on a keyboard presented on the touch screen display. Throughout this description of the invention, it should be appreciated that any entry of keystrokes can be performed in either manner. Similarly, any selection of an on-screen button or indication of an area can be performed either by touching the screen or by making an appropriate selection by using a mouse or other pointing device.

After logging in, the computer evaluates the username and password and presents to the user on the display those menu choices that the user is entitled to access. In order to place an inventory order, the user touches the appropriate selection on the screen and places the order. The order can be placed in a variety of ways. For example, if the survey has been performed using a hand-held device, the device is connected to the computer 30 and the order is electronically transmitted 104 to the computer. Alternatively, the order is entered manually 106. Entering the order manually preferably includes presenting to the user on the display a listing of possible items to order. By touching the desired items and selecting quantities, the user places the order. Likewise, the user can simply enter item numbers and indicate quantities.

After the order is entered, the computer processes the entered data and presents the completed order on the display. The user is then able to review the order to confirm accuracy. If the order is correct, the user sends the order to the vendor 108 by touching an appropriate button on the touch screen to submit the order. In response to the submit request, the order is sent over the network 56 to the remote vendor 58. The computer can alternatively be programmed to place the order by other means, for example sending a facsimile over the telephone lines 64 to the appropriate vendor. Thus, after downloading the order, the user optionally instructs the system to send the order to the vendor using a pre-programmed or contemporaneously entered facsimile number.

Finally, after sending the order, the user logs out 110. Accordingly, the user indicates that all ordering activities have been completed and selects logout as a choice from among the remaining menu options. Logging out returns the system to its static state, with the full range of menu options available to customers in the store.

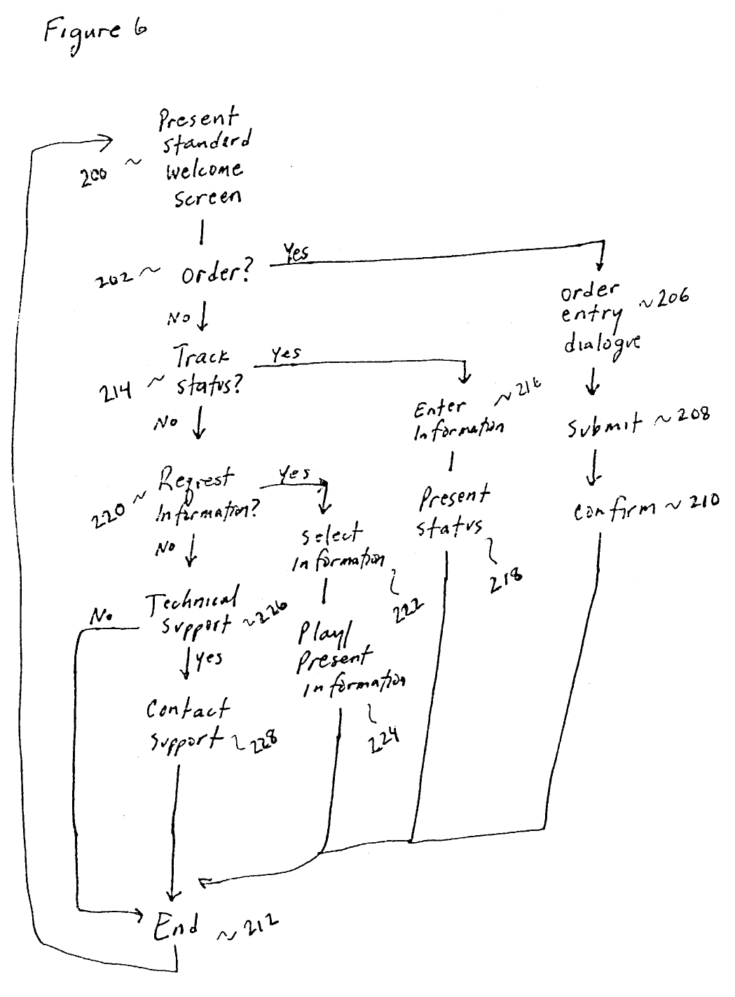

FIG. 6 depicts a range of possible options available to customers to obtain information, purchase items, place special orders, or track status. The display initially presents the standard welcome screen 200, for example as illustrated in FIG. 2. Among the various menu choices is the option to place a special order 202. A customer can begin an order process by touching the touch-screen order button.

As an alternative, the system may include voice activation and menu choices that are audible and voice-driven, rather than touch-menu driven. Thus, in a voice activated system the microphone 80 continually monitors sounds in the vicinity of the display. The signals received by the microphone are evaluated by voice recognition software stored within the computer memory and operated by the computer processor. Thus, the computer continually monitors sounds in the vicinity of the display for recognized terms. Any of a variety of commercially available voice recognition software systems are suitable for this purpose.

As the computer monitors sounds received, it compares those sounds, using the voice recognition software, to recognized commands stored in memory. Thus, the memory includes particular audible commands that it is listening for, and the recognition of such commands will prompt various actions by the computer system. For example, recognizing the command “order” will be treated as the functional equivalent of touching the display order button and the ordering system will proceed as if that had occurred (see FIG. 6, reference no. 202). Likewise, other voice commands such as “status,” “information,” “support,” or “training” will also prompt subsequent actions just as if corresponding touch screen buttons were activated. All or any subset of the commands in the system can therefore be activated by voice or touch screen.

Once a user selects the special order button by touching that button as presented on the touch screen display (or by using voice commands), the computer causes the display to present an order entry dialogue 206. The order entry dialogue can vary greatly depending on the number and type of products available. Standard HTML-based, menu-driven arrangements for products available to be ordered are widely used, for example, by a great number of Internet vendors. The present system preferably employs a similar arrangement, with product choices depicted with sample photographs or illustrations and screen locations for users to indicate the products they would like to order.

In an alternate form of the invention, the system accesses a stored database of customer information when a customer accesses the in-store computer. Accordingly, when the customer touches an appropriate button requesting information, to place an order, check status, or conduct other business, the customer is asked to provide a name or other identifying information such as a password, codeword, customer identification number, or order number. This information is then passed to the remote computer where it is also accessible by remote personnel who are automatically presented with an associated customer record upon an appropriate query from the in-store computer. With the customer record available, the remote personnel can provide individualized attention, address the customer by name, and quickly answer questions about order status.

Moreover, the system itself can be remotely hosted, rather than on the local computer. Thus, when selecting the order button, the system can cause the computer to access a remote server over the internet much as any other home or business computer would. Once the system accesses the remote computer, it retrieves Web pages in HTML or other formats to present pages on the display. The user then selects the items for the special order, with the system employing a standard shopping cart model or any other arrangement to obtain the order from the customer.

Special orders can then be placed by choosing from among the options available. Alternatively, customers can enter SKU numbers or can scan bar codes of products from adjacent store shelves or store catalogs to indicate products to be ordered. In this form, the in-store computer includes a database associating SKU or bar codes with individual products, so that when such codes are entered the in-store computer determines the product to be ordered. Alternatively, the product codes are entered into the in-store input device and communicated to the remote vendor computer to determine, via a remotely stored database, the precise product ordered. The menu-driven order entry dialogue requests appropriate information related to quantities, colors, sizes, measurements, or other product-related information, as necessary.

In a simple form, as described above, customers are able to place orders by selecting products from a menu of items presented on the display, or by entering a product name, SKU, bar code, or other product identification. Alternatively, in a more complicated form, the menu of items presented on the display is accompanied by photographs of the items available for purchase.

As part of the order entry process, the computer presents dialogue on the display requesting customer contact information such as name, address, phone number, and credit card or other billing information. In addition, the user is asked for an email address so that it can send a confirmation by email.

The customer reviews the order and, once the user is satisfied that it is correct, submits it 208. The submission step either stores the order in the computer memory for later transmission to the vendor, or contemporaneously sends the order to the vendor over the Internet or phone lines. After submission, the customer is provided with a confirmation 210. The confirmation will present a confirmation screen on the display with a confirmation number, and may optionally send a confirmation to the customer's provided email address. The screen confirmation can be printed on the attached printer so that the customer will have a printed copy. To accomplish printing, the computer is either programmed to cause automatic printing upon confirmation, or to present a touch screen button and a request that the user press the button if a hard copy is desired. After the order confirmation process is completed, the order entry is ended 212 and the system returns to the standard welcome screen 200.

The welcome screen also provides a touch screen button allowing customers to track the status of a previous order 214. Upon pressing the associated touch screen button, the computer causes the display to present a dialogue requesting information associated with the previous order 216. The information could be any of a variety of subjects, such as a confirmation number, customer identification, customer name, or other.

After submitting information sufficient to allow the computer to retrieve the order, the computer retrieves the record associated with the special order. The retrieval can involve accessing a remote vendor computer over the Internet, or can involve accessing a database of stored customer orders within a memory associated with the computer. In either event, once the status is accessed, it is presented 218 on the display to indicate whether the order, for example, has been processed, shipped, or has arrived at the store. The status information can be printed on the attached computer by pressing an appropriate touch screen button. Once the status presentation has been printed or sufficient time has elapsed after presentation, the status tracking dialogue ends 212 and the system returns to the standard welcome screen 200.

As an additional option, the standard welcome screen includes one or more touch screen buttons allowing users to request information 220. In this sense, “information” can be any type of instructional, audio-visual, or other content. After a user indicates that information is requested by pressing the appropriate touch screen button, the computer causes the display to present a menu of informational choices. The menu can take any form, and can be categorized, for example, into product groupings or other topical arrangements.

The user then selects a desired informational topic 222, causing the computer to retrieve the information from an associated memory or from a remote computer over the Internet and present it on the display 224. The information can include, for example, an audio-visual presentation demonstrating how to install or use a product at home or a written text of step-by-step instructions relating to product use. After the information has been presented, the system returns to the menu information selection screen 222 allowing the user to select an additional option. If no other options are desired, the information request dialogue ends 212, and the system returns to the standard welcome screen 200.

As an additional example of a customer use, customers can select technical support 226 from the standard welcome screen. Because technical support may be desired at any step, including, for example, during placing a special order, order tracking, or viewing product information, the display preferably includes an on-screen button for technical support at all times. Likewise, in a voice recognition embodiment, the customer may say “technical support” (or some other equivalent command) at any time. The voice recognition software component will evaluate and recognize the command, causing a link to technical support personnel in the same manner as if the technical support button had been touched.

Once technical support is requested by the user, the system accesses a remote assistant 228 in any of a variety of ways. In a preferred form, when a customer touches a technical support button, the computer accesses a remote vendor computer over the Internet. At the remote vendor location, a live vendor employee receives a notice that technical support has been requested, and a communication link between the in-store computer and the remote vendor computer is established. The remote vendor computer preferably includes a video camera and microphone allowing the remote computer to send audio-visual signals to the in-store computer which presents them on the display. Accordingly, the customer is able to view the remote vendor employee and ask questions directly, viewing the employee while he or she provides answers.

In accordance with this aspect of the invention, the remote vendor may have any number of separate workstations, each having a computer networked to a vendor server. Likewise, any number of in-store computers may be installed at various store locations around the world. Accordingly, there are preferably sufficient remote vendor workstations and corresponding personnel operating them to satisfy the demands of customers accessing the in-store computers installed in various locations around the world.

Preferably, the in-store system includes a microphone and camera as well, as shown in FIG. 4. This arrangement allows the remote vendor to see the customer as well, because the in-store computer sends the received images and video to the remote computer for presentation on an associated display. It is also advantageous because the customer can hold samples or products within the in-store camera field of view, facilitating better answers from the vendor employee. Using this arrangement, the customer and vendor employee carry on a dialogue as appropriate until the technical assistance is completed.

During the course of the exchange between the customer and the remote vendor, the remote vendor can take control of all or a portion of the presentation on the in-store display. The remote vendor computer, which is communication over the Internet with the in-store computer, includes a memory with stored depictions of products, training videos, sample videos, installation videos, and other information. Preferably, such files of information are stored in a format that makes them readily transferable over the Internet for presentation on the display. The remote vendor can then select from any of them, choosing from a menu of stored information, and cause them to be sent over the Internet to the in-store computer for display. As an alternative, the files themselves are stored in a memory associated with the in-store computer, so that the remote vendor sends instructions to the in-store computer regarding which files to select from the in-store computer memory rather than sending the files themselves. This form may well be faster and preferable, particularly for those files that are large. In this fashion, the remote vendor can present to the in-store customer product options for purchase or any other information to assist the customer.

As an alternative to the Internet-based communication channel, the computer may alternatively dial a remote technical assistance employee using a phone line. As with the Internet channel, the phone line can provide an audio-visual communication between the customer and the remote vendor, with images of the vendor employee presented on the display and questions answered and played on the associated speaker.

As another alternative, using the phone line or Internet channels, the in-store system may provide an audio-only technical assistance format. In the preferred form of this alternative, the system places a remote phone call to the vendor employee. The display presents a still photograph of the employee during the course of the phone call, rather than a live moving video image of the remote vendor personnel.

After the technical support questions are answered, the technical support routine ends 212, and the display returns to the standard welcome screen.

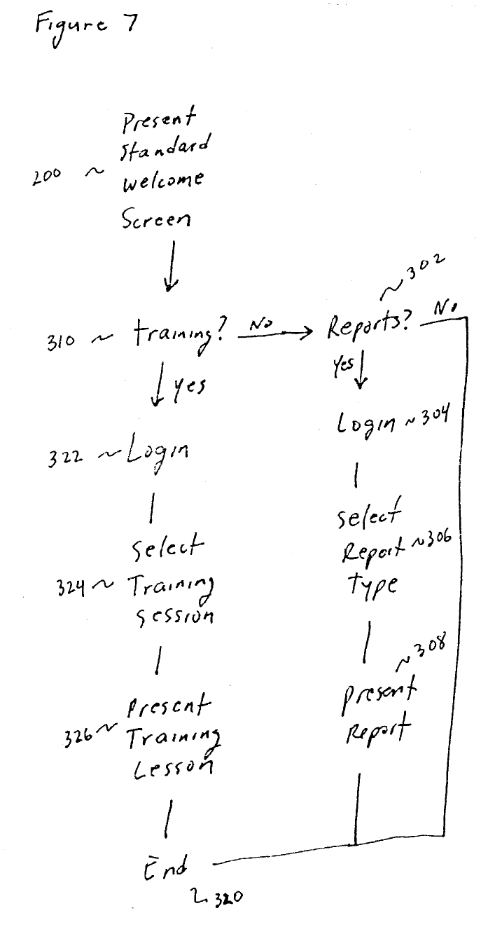

The in-store system can also provide an array of store employee and contractor training functions, as shown in FIG. 7. Starting from the standard welcome screen 200, a user desiring training or similar uses makes an appropriate selection from the menu requesting training 310, a request for reports 302, or other administrative functions. In order to access these features, the user must login 304, 322. As shown in FIG. 7, the administrative menu choices are on the public screen but can only be accessed after a successful login. As an alternative, none of the administrative choices are publicly visible on the standard welcome screen, but the login window is always present. Consistent with this alternative, when a user enters a username and password that are recognized by the computer, the computer causes the display to present an administrative welcome screen listing available administrative options such as training, reports, configuration set-up, and others.

After a successful login and the selection of training, the computer causes the display to present listings of available training options 324. The user then touches the screen in appropriate locations to indicate a desired training topic. Touching the screen causes the computer to retrieve from memory (including, for example, an associated CD or DVD player) an audio-visual training video and play it on the display 326. Alternatively, the computer will retrieve the training content from a remote computer over the Internet. As yet another option, the training can include a live presentation from a remote individual, as with the technical support format described above. The live presentation can accompany a contemporaneously playing audio-visual training session, with the video portion of each being presented on different portions of the display.

The training sessions available can cover a wide range of topics, such as general product familiarity, how to install products, how to stock and rotate products on shelves, and new products to be arriving soon. After the training session has been completed 320, the system returns to an administrative welcome screen, or, if administrative functions are finished, to the standard welcome screen 200.

The system can also be accessed for a variety of reporting functions, by logging in and indicating reports are desired. A menu of report types is provided, from which the user selects one or more requested reports 306. Reports can include, for example, the number of times customers have used the system, number and type of technical support inquiries, number and type of training or informational inquiries, and number and type of special orders made. Any of the foregoing reports is presented on the display 308, and can be printed on the attached printer by pressing an appropriate touch-screen button. Once reporting requests are completed, the system returns to the administrative welcome screen or the standard welcome screen 200, as appropriate.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. An interactive sales support system, comprising
An in-store computer having a processor, the computer being configured with a remote computer over a network;
a display associated with the in-store computer, the display being placed in a location at which it is accessible by customers;
a memory accessible by the processor and containing stored programming instructions operable by the processor to enable the processor to retrieve information in response to an input by a customer and to present the information on the display; and
a microphone and a speaker configured to send and receive audio signals over a communication channel to and from a remote support location, the microphone and speaker being placed in a location at which they are accessible by customers, and further located such that communication with the remote support location over the microphone and speaker is audible within the field of view of the display.

2. The system of claim 1, wherein the display is located in a store nearby goods or services for sale, and further wherein the information is related to the goods or services for sale.

3. The system of claim 2, wherein the display further comprises a touch-sensitive screen.

4. The system of claim 3, wherein the communication channel comprises a telephone line.

5. The system of claim 3, wherein the communication channel comprises the Internet.

6. The system of claim 3, wherein at least one of the microphone or speaker is in communication with the computer.

7. The system of claim 3, wherein the information further comprises an image of the remote support person.

8. The system of claim 7, wherein the image comprises a still photograph.

9. The system of claim 7, wherein the image comprises a video image of the remote person moving substantially synchronously with the audio signal played on the speaker.

10. The system of claim 3, wherein the computer is configured to cause the display to present stored product content.

11. The system of claim 10, wherein the stored product content is stored in the memory.

12. The system of claim 10, wherein the stored content is stored on a remote computer memory.

13. The system of claim 12, wherein the remote computer memory is associated with a remote vendor computer, and further wherein the remote vendor computer is configured for communication with the in-store computer over a network.

14. The system of claim 10, wherein the stored product content comprises information related to at least one of product installation or product use.

15. The system of claim 3, wherein the stored programming instructions further comprise instructions to cause the display to present options to order products and to receive requests from a user to order the products.

16. The system of claim 15, wherein the stored programming instructions further comprise instructions to cause the request to order products to be submitted to a remote vendor.

17. The system of claim 16, wherein the stored programming instructions further comprise instructions to send a confirmation message to an email address associated with the user.

18. The system of claim 3, wherein the stored programming instructions further comprise instructions to cause the processor to retrieve the status of a previous order and present the status on the display upon request by a user.

19. The system of claim 3, wherein the stored programming instructions further comprise sending customer identifying information to a remote vendor computer to retrieve data related to the customer.

20. The system of claim 3, wherein the memory further comprises stored files containing audio or video training information.

21. The system of claim 3, wherein the stored programming instructions further comprise voice recognition instructions to recognize one or more commands from a customer.
